(19) United States
(12) Patent Application Publication
(10) Pub. No.: US 2009/0258972 A1
(43) Pub. Date: Oct. 15, 2009

(54) Building material composition

(75) Inventors: Serban Iliuta, Montreal (CA); Hua Qin Liu, Pointe-Claire (CA); Vu Q. Nguyen, Arnold, MD (US)

Correspondence Address: DOWELL & DOWELL P.C., 103 Oronoco St., Suite 220, Alexandria, VA, 22314, US

(73) Assignee: BITUMAR INC., Montreal (CA)

(21) Appl. No.: 12/385,659

(22) Filed: Apr. 15, 2009

(30) Foreign Application Priority Data
Apr. 15, 2008 (CA) 2629114

(51) Int. Cl. C08L 1/00; C08K 3/04

(52) U.S. Cl. 524/35; 524/63; 264/171.1; 264/328.1

(57) ABSTRACT

There is provided a building material composition comprising a filler and a polymer wherein the filler comprises coke and the polymer comprises polyethylene. A process for making the same comprises loading the polyethylene with coke and forming the resulting composition into a building material, the amount of coke being selected depending on the desired building material.

### FIELD OF THE INVENTION

The present invention relates to polymers and their use in the construction industry. More specifically, the present invention is concerned with a building material composition.

### BACKGROUND OF THE INVENTION

In the art of making building materials such as panels for roof tiles, sidings for homes or the like, it is common to use multi-component formulations, which comprise blends of virgin or recycled polymers and one or more fillers.

Common sloped roofs usually comprise a roof deck, underlayment and roof covering. Roof decks are usually made of plywood or a similar material. Underlayments provide secondary protection and are one of many choices of weatherproofing membranes. The roof covering is directly exposed to the environment and provides the main barrier against weather elements. Several classes of roof coverings are known: asphalt shingles, slate, wood shakes, clay or concrete. More recently, synthetic coverings have been developed. The following are a few examples.

Enviroshake™ is a synthetic tile made of thermoplastic polymers, natural fibers and recycled crumb rubber. This type of tile is intended to simulate cedar shakes.

Euroslate™ is similar to Enviroshake™ and is made of recycled crumb rubber and proprietary binders.

Roofroc™ is primarily made of limestone and recycled plastics.

Geotile™ is made of polyethylene and cellulose fibers and is intended to replace clay tiles.

United States patent application No. 2007/0022692A1 to Friedman et al, describes a synthetic roofing shingle or tile comprised of a core portion and a skin portion. The core material is of greater thickness than the skin material and is comprised of a highly filled polymer. The material of the skin is a more expensive material than that of the core. Thus the skin material is comprised of less filled polymer or virgin polymers. Examples of the polymers of the core material are Polyvinylchloride, Polyethylene, Polypropylene, Polybutene, Polymethylpentene, Polyacrylates, Polyethyleneterephtalate, Polybutyleneterephtalate, Polyethylenenaphtalate, Ethylene-Propylene-diene Monomer Copolymers. The fillers are selected from the group consisting of mineral filler, organic filler, nanofiller, reinforcing filler, reinforcing fiber and recycled polymers.

U.S. Pat. No. 6,702,969 B2 to Matuana et al describes a method of making wood-based composite boards. The wood composite comprises a plurality of wood pieces, a thermoset resin capable of binding the wood pieces and a filler having a high thermal conductivity. The thermoset resin is selected from the group consisting of phenolic resin, MDI resin, urea resin, melamine resin, epoxy resin, urethane resin, particularly non-foaming urethane resins and mixtures thereof. The filler is selected from a group consisting of metals, carbon filler such as natural graphite, synthetic graphite, scrap graphite, carbon black, carbon fiber, metal (such as nickel) coated carbon fiber, carbon nanotubes, coke and mixtures thereof.

Despite all the advances that have been made in the art, there still remains a need for building material compositions.

### SUMMARY OF THE INVENTION

More specifically, in accordance with the present invention, there is provided a building material composition comprising a filler and a polymer, wherein the filler comprises coke and the polymer comprises polyethylene.

The invention also provides a process for making a composition comprising determining a building material to be formed from the composition; selecting an amount of coke in a filler according to the building material to be formed from the composition; and loading a polymer comprising polyethylene with the filler.

The invention also provides a process for making the composition according to the present invention, wherein the filler comprising the amount of coke is milled into a powder and the powder is co-extruded with the polymer comprising polyethylene.

The invention also provides a process for making a building material, comprising:
selecting an amount of coke according to desired properties of the building material;
loading a polymer comprising polyethylene with a filler comprising the selected amount of coke thereby producing a composition; and
shaping the composition into the building material.

### BRIEF DESCRIPTION OF THE DRAWINGS

In the appended drawings:

FIG. 1 is a bar graph showing the average modulus of compositions II, III, IV, V, VI and VII of Table 1 as for unfilled polyethylene (each bar is labeled with the corresponding composition number);

FIG. 2 is a bar graph showing the maximum stress of compositions II, III, IV, V, VI and VII of Table 1 as well as for unfilled polyethylene (each bar is labeled with the corresponding composition number);

FIG. 3 is a bar graph showing the average modulus of compositions I-X of Table 1 and unfilled polyethylene as a control (the values of FIG. 1 are also included) (each bar is labeled with the corresponding composition number);

FIG. 4 is a bar graph showing the maximum stress of compositions I-X of Table 1 and unfilled polyethylene as a control (the values of FIG. 2 are also included) (each bar is labeled with the corresponding composition number);

FIG. 5 shows the infrared spectra of compositions II and III of Table 1 as well as unfilled polyethylene as a control, before and after 45 days of UV aging.

FIG. 6 shows a schematic diagram of the set up used for the preparation of the compositions of the present invention.

### DETAILED DESCRIPTION OF THE INVENTION

The present invention provides a novel building material composition. The composition comprises coke-filled polyethylene. The building materials to be made from these compositions include, but are not restricted to, panels, tiles for sloped roofs, tiles for flat roofs and sidings for homes for example.

As known in the art, a filler is a substance that is used to alter the properties of a material that it fills. For example, fillers are used to provide bulk, to enhance the electrical conductivity of the polymers, to alter the physical properties of the polymers, etc.

Coke is generally a by-product or waste of crude oil processing. It is known to be an inexpensive material. Thus, by using coke as a filler, the overall cost of final products is greatly reduced, compared with using any other more expensive filler. As used herein, coke is distinguished from carbon black. In addition, all types of coke are within the scope of the invention. Furthermore, coke obtained via any process may be used. This includes obtaining coke from coal or from crude oil. Coke that is obtained from crude oil is known in the art as petroleum coke. Additionally, coke of any range of particle sizes may be used such as for example coke pearl, coke powder, coke breeze, coke flour, etc. Coke of smaller particle size, such as fine coke powder, may be generally preferred. Coke having a particle size of 0.5 mm or less may be used. Coke having a fine particle size, such as below 0.5 mm allows the production of more homogenous compositions (compared with coke having particle size larger than 0.5 mm), which generally show improved mechanical properties.

The present inventors have surprisingly found that high amounts of coke can be added without interfering in the making of building materials. Indeed, loading polyethylene with high amounts of coke is found to yield homogeneous compositions that are usable for molding in the same manner as the unfilled polymer is. Although adding coke makes the material more fragile, this tendency does not affect the intended use of the compositions of the present invention, which are still usable in the making of building materials. In the case where the loaded polyethylene does not have the desired properties for the intended building material, the latter may be made thicker in order to improve its properties, including the elastic modulus of the material and the maximum stress that the material can withstand. The amount of coke that can be added to the composition may be as high as 90% w/w.

Characterization tests of compositions of the present invention are performed to assess the effect of coke on the mechanical properties of polyethylene. The mechanical properties of the coke-filled polymers are assessed using mainly tensile tests, however any kind of testing available in the art may be used. It is found that the average modulus of the coke-filled polymers and the maximum stress that they can withstand are different than those of the unfilled polymers. As a result, the specific amount of coke to be added in order to obtain a composition having a specific modulus and a specific maximum stress for a desired building material, can be selected.

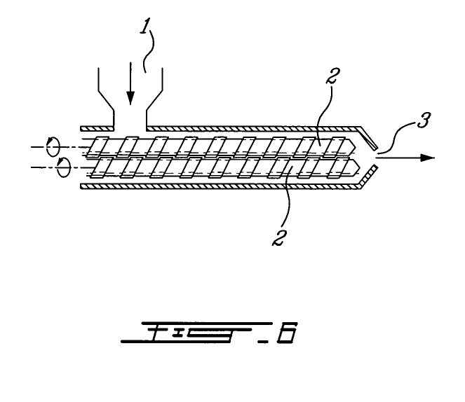

The inventors have also surprisingly found that coke slows down the aging process of the compositions, due for example to UV light. Indeed, it is a well-known problem that most organic compounds, including polymers and other types of resins, undergo a process in which they degrade due to the breaking of chemical bonds, which results in poor mechanical properties. Thus, enhancing the material's resistance to UV light greatly increases the lifespan thereof. FIG. 5 shows the infrared spectra of two compositions, as well as the unfilled resin A, before and after 45 days of UV aging. It is seen that the aging process causes an absorption band to appear at 668 cm⁻¹, which indicates that upon aging, changes occur in the chemical structure of the compositions. The absorption band at 668 cm⁻¹ can be attributed to terminal double bonds. Indeed aging may occur through chain scission, which can lead to the formation of terminal double bonds. FIG. 5 also shows that the intensity of this band is smaller for the coke-filled polyethylene, which is consistent with an inhibiting action of the coke particles on the aging process.

In addition to coke and polyethylene, other components may be added to the compositions of the present invention. For example, fibers may be added. These fibers may be fibers commonly used with polymers and filled polymers, including natural fibers such as cellulose, for example. Fibers have the potential of further lowering production costs, depending on the type of fibers that is used. Using fibers also allows lowering the bulk density of the resulting material. Thus, for the same volume of polymer, adding fibers yields a larger volume of the resulting material. Fibers can represent as much as 90% of the weight of the resulting material.

Binding between various elements of the present compositions may be enhanced by including surfactants. There is a wealth of surfactants available in the art such as ionic, anionic, zwitterionic and non-ionic surfactants.

In the context of the present invention, the term polyethylene is intended to cover all types of polyethylene polymer including high-density polyethylene (HDPE), low-density polyethylene (LDPE) and any combination of polyethylene, high-density polyethylene and low-density polyethylene. There are no specific limitations pertaining to the molecular weight of the polymer. A person of skill in the art will recognize that any molecular weight that gives a good combination of strength and flexibility of the polymer can be used in the context of the present invention. As noted above, although there are no specific limitations regarding the polyethylene polymer that is used, HDPE is generally stronger and stiffer than LDPE.

The compositions of the present invention are made by processes that allow loading a polymer with the filler, as known in the art. For example, the filler may be milled into a powder and then co-extruded with the polymer. In Example I below, the coke is milled to a particle size of 0.5 mm or less.

Methods other than co-extrusion may be used and are within the scope of the present invention. For example, the filler and the polymer may be compressed together. Other methods of blending the coke and the polyethylene may be used and are within the scope of the invention. These include batch mixing, for example.

Subsequent to the loading of the polyethylene with coke, the compositions of the present invention are shaped into desired building materials, by molding or injection molding for instance. Methods other than molding or injection molding may be used and are within the scope of the present invention. Some of these include extrusion and stamping, for example.

Other objects, advantages and features of the present invention will become more apparent upon reading of the following non-restrictive description of specific embodiments thereof, given by way of example only with reference to the accompanying drawings.

### Description of Embodiments

The present invention is illustrated in further details by the following non-limiting examples.

### EXAMPLE I

Two different lots of petroleum coke, labeled grade 1 and grade 2, respectively, obtained from two different suppliers, are loaded into four different grades of high-density polyethylene (HDPE), labeled A-D, respectively. A grade can vary from another by average molecular weight, molecular distribution, degree of branching, color, etc. Table 1 shows ten compositions of HDPE and petroleum coke that are thus prepared. All percentages are in weight percent based on the total weight of the composition.

TABLE 1
Various compositions of polyethylene and coke:

| | | Coke | HDPE content | Coke content |
|---|---|---|---|---|
| Composition # | HDPE grade | grade | (%) | (%) |
| I | A | 1 | 56 | 44 |
| II | A | 2 | 56 | 44 |
| III | A | 2 | 70 | 30 |
| IV | B | 2 | 56 | 44 |
| V | B | 2 | 70 | 30 |
| VI | C | 2 | 56 | 44 |
| VII | C | 2 | 70 | 30 |
| VIII | D | 2 | 56 | 44 |
| IX | D | 2 | 40 | 60 |

| | |
|---|---|
| X | 90% of composition I + 10% natural fibers |

The coke is fed into a primary jaw crusher, the resulting material being subsequently transferred into a secondary cone crusher. At this stage, the particle size of the coke is approximately equal to 20 cm or less. Of course, any particle size can be used at this stage. Cone crushers are known to yield any range of particle sizes (even more than 1 m). A final size reduction step is carried out using rod mills to reduce the particle size to 0.5 mm or less. The fine coke powder is then co-extruded with HDPE (refer to FIG. 6), which is available in pellet form, by simultaneously feeding the coke and the polymer pellets into a hopper (1) at predetermined rates, such that the desired compositions are obtained. A Leistritz™ twin-screw (screw diameter: 18 mm) extruder is used for the co-extrusion. FIG. 6 shows the hopper (1), where the polymer pellets and the coke are fed, and two screws (2). The polymer melts and the screws (2) mix it with the coke powder and push the mixture through a die (3) (which is approximately 2 mm in diameter). The length of the screws (2) has several zones that can be heated individually (refer to the different heating zones in Table 2). The resulting compositions are homogenous and are extruded as continuous threads, which are then cut into approximately 1 to 2 mm pellets (not shown). Those pellets are used for molding in the same manner as would the pellets of the corresponding unfilled polymer. Cellulose fibers extracted from hemp are added through a lateral feeding orifice to a composition of polymer and coke for blend X (not shown).

Table 2 shows the extrusion temperature profile used for each grade of polyethylene blended with coke. The same temperature profile is used for unfilled polyethylene.

TABLE 2
Temperature profile for the extrusion:

| | Heating | Heating | Heating | Heating | Heating | Heating | Heating | Heating |
|---|---|---|---|---|---|---|---|---|
| | zone | zone | zone | zone | zone | zone | zone | zone |
| | #1 | #2 | #3 | #4 | #5 | #6 | #7 | #8 |
| | (° C.) | (° C.) | (° C.) | (° C.) | (° C.) | (° C.) | (° C.) | (° C.) |
| HDPE A | 190 | 195 | 195 | 200 | 205 | 205 | 210 | 215 |
| HDPE B | 205 | 210 | 210 | 215 | 220 | 220 | 225 | 225 |
| HDPE C | 205 | 210 | 210 | 215 | 220 | 220 | 225 | 225 |
| HDPE D | 185 | 187 | 190 | 190 | 193 | 193 | 197 | 200 |

Composition (IX), containing 60%, coke is prepared by running two extrusion cycles, adding approximately half of the required amount of coke in the first cycle, and the remaining in the second cycle.

All compositions are then injection molded using a Sumitomo™ injection-molding machine and tensile tests are conducted using an Instron™ instrument. For the tensile tests, a 500 kg load cell and a 50 mm/min traction speed are used.

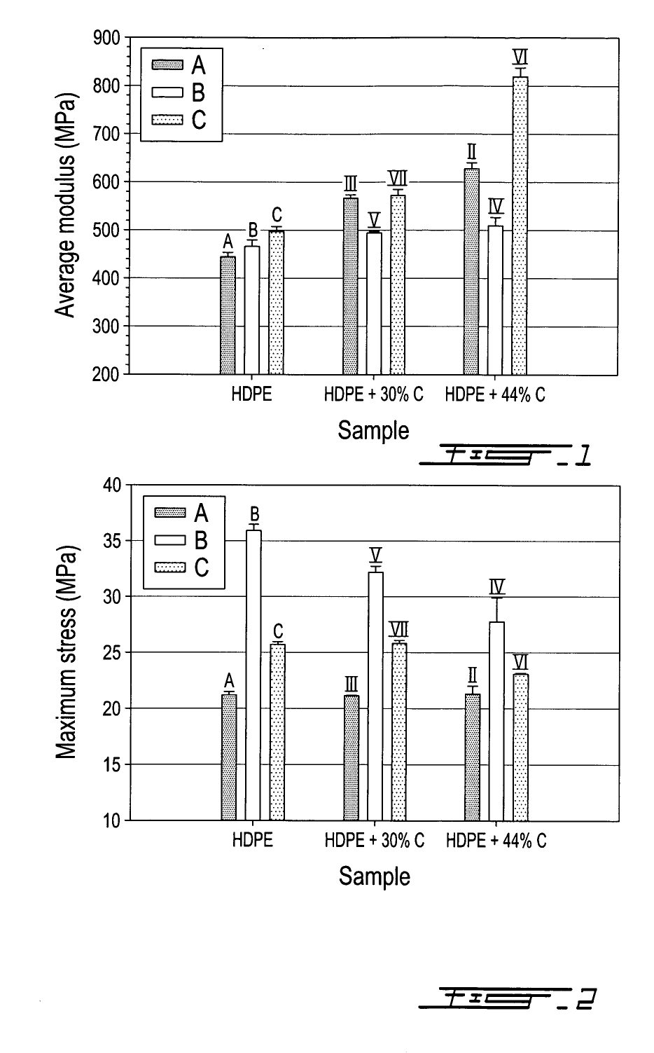

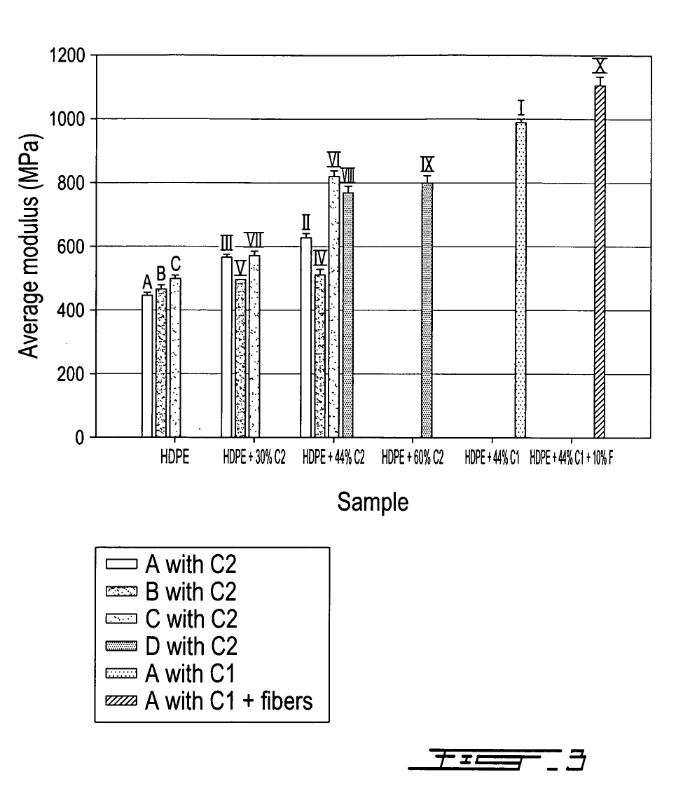

Tensile tests are performed on compositions II, III, IV, V, VI and VII of Table I. The results are shown in FIGS. 1 and 2.

FIG. 1 is a bar graph showing the average modulus in MPa as a function of the concentration of coke for each composition and for unfilled polyethylene as a control. FIG. 1 shows that the average modulus of the compositions is increased with the increase of the percentage of coke present. Polyethylene C shows the largest increase of modulus.

FIG. 2 is a bar graph showing the maximum stress in MPa for each composition and for unfilled polyethylene as a control. FIG. 2 shows that the maximum stress is generally decreased with the increase of the percentage of coke present, even more so in the case of polyethylene B. The maximum stress of polymer A advantageously undergoes very little change after loading with coke. The maximum stress of polymer C is practically unchanged after loading with 30% of coke. However, the maximum stress of polymer C decreases when loaded with 44% of coke.

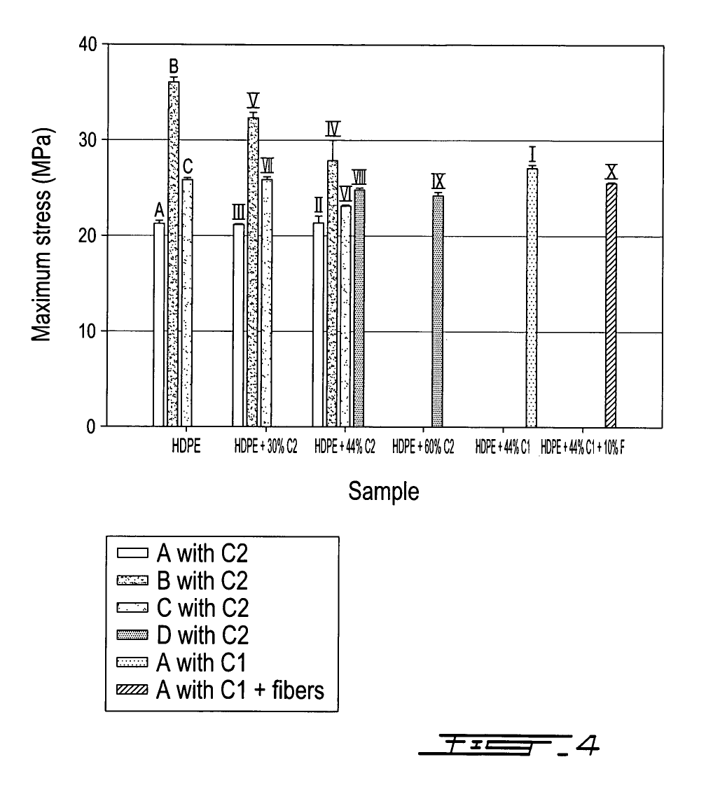

Tensile tests are performed on the remaining compositions of Table 1, namely I, VIII, IX and X. FIG. 3 is a bar graph showing the modulus of composition I-X of Table I (data of FIG. 1 are included in FIG. 3), and unfilled polyethylene as a control as a function of the concentration of coke. FIG. 3 shows that the modulus of the composition generally increases with increasing concentrations of coke.

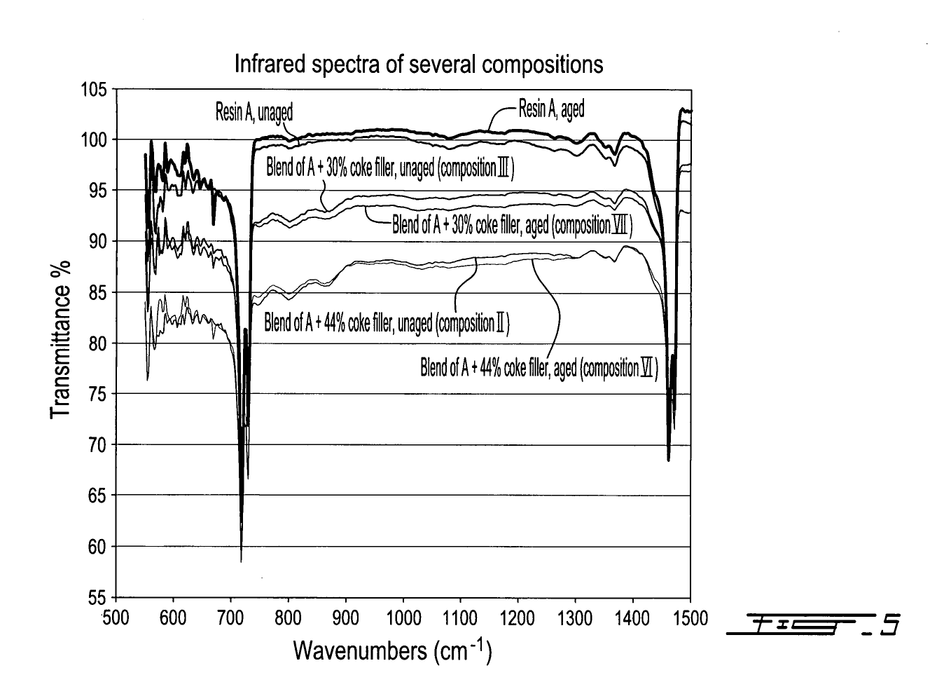

FIG. 4 is a bar graph showing the maximum stress of composition I-X of Table I (data of FIG. 2 are included in FIG. 4) and unfilled polyethylene as a control as a function of the concentration of coke. FIG. 4 shows that the maximum strength generally decreases when the concentration of coke increases.

### EXAMPLE II

The effect of UV light on compositions of the present invention is tested. FIG. 5 shows infrared spectra of composition III and II of Table I as well as unfilled polyethylene, before and after 45 days of UV aging. The aging is done using a Blak-Ray® UV lamp model B 100-AP. Specimens are placed under the lamp at a distance of approximately 10 cm. The wavelength used was 365 nm. As can be seen in FIG. 5, the aging process causes an absorption band to appear at 668 cm⁻¹, which can be attributed to terminal double bonds. The intensity of this band is smaller for the filled polyethylene, consistent with an inhibiting action of the coke particles on the aging process.

Although the present invention has been described hereinabove by way of specific embodiments thereof, it can be modified, without departing from the nature and teachings of the subject invention as defined in the appended claims.

1. A building material composition comprising a filler and a polymer, wherein said filler comprises coke and said polymer comprises polyethylene.

2. The composition according to claim 1, wherein said filler consists of coke.

3. The composition according to claim 1, wherein said polymer consists of polyethylene.

4. The composition according to claim 1, wherein said polyethylene is (i) high-density polyethylene, (ii) low-density polyethylene or (iii) combinations thereof.

5. The composition according to claim 1, wherein said composition comprises a weight percent of polyethylene of up to about 90% based on the total weight of said composition.

6. The composition according to claim 1, wherein said composition comprises a weight percent of coke of up to about 90% based on the total weight of the composition.

7. The composition according to claim 1, wherein said composition further comprises fibers.

8. The composition according to claim 7, wherein said composition comprises a weight percent of up to about 90% of said fibers based on the total weight of said composition.

9. The composition according to claim 8, wherein said fibers are natural fibers.

10. The composition according to claim 9, wherein said natural fibers are cellulose fibers.

11. The composition according to claim 10, wherein said fibers are extracted from hemp.

12. The composition according to claim 1, wherein said coke is petroleum coke.

13. The composition according to claim 1, wherein said coke is (i) coke breeze, (ii) coke flour, (iii) coke powder, or (iv) combinations thereof.

14. The composition according to claim 1, wherein said coke is in a powder form of a particle size of at most about 0.5 mm.

15. The composition according to claim 1, wherein said composition is a co-extrudate of said filler and said polymer.

16. The composition according to claim 1, wherein said composition further comprises surfactants.

17. Use of the composition according to claim 1, to mold a building material.

18. The use according to claim 17, wherein said building material is one of: (i) a panel, (ii) a tile for sloped roofs, (iii) a tile for flat roofs or (iv) a siding for homes.

19. A process for making a composition comprising determining a building material to be formed from the composition; selecting an amount of coke in a filler according to the building material to be formed from the composition; and loading a polymer comprising polyethylene with the filler.

20. The process according to claim 19, comprising milling the filler comprising the amount of coke into a powder and co-extruding the powder with the polymer comprising polyethylene.

21. The process according to claim 19, comprising adding fiber to said polymer comprising polyethylene and said filler comprising the amount of coke.

22. The process according to claim 19, comprising milling the amount of coke into a powder of a particle size of at most 0.5 mm.

23. A process for making a building material, comprising:
selecting an amount of coke according to desired properties of the building material;
loading a polymer comprising polyethylene with a filler comprising the selected amount of coke thereby producing a composition; and
shaping the composition into the building material.

24. The process according to claim 23, comprising adding fibers, a surfactant or a combination thereof, to said polymer and said filler.

25. The process according to claim 23, wherein said loading comprises co-extruding the filler comprising the selected amount of coke and the polymer comprising polyethylene.

26. The process according to claim 23, wherein said shaping comprises molding the composition or injection-molding the composition.

27. The process according to claim 23, said loading comprising reducing the filler comprising the selected amount of coke into a powder and co-extruding the powder with the polymer comprising polyethylene.

28. The process according to claim 27, wherein said reducing the filler into a powder comprises reducing the filler into a powder having a particle size of at most 0.5 mm.

29. A building material made by the process according to claim 19.

30. A building material made from the composition according to claim 19.

31. The building material according to claim 27, wherein said building material is one of (i) a panel, (ii) a tile for sloped roofs, (iii) a tile for flat roofs or (iv) a siding for homes.

32. A building material made by the process according to claim 23.

33. A building material made from the composition according to claim 23.
